(19) United States
(12) Patent Application Publication
(10) Pub. No.: US 2023/0229987 A1
(43) Pub. Date: Jul. 20, 2023

(54) METHODS FOR VALIDATING THE VERACITY OF A COMPLETED TASK

(71) Applicant: Unira, Inc., Miami, FL (US)

(72) Inventors: Jeremy Gallego Eckstein, Miami, FL (US); Cariel Cohen, Boca Raton, FL (US)

(21) Appl. No.: 18/095,974

(22) Filed: Jan. 11, 2023

Related U.S. Application Data
(60) Provisional application No. 63/299,642, filed on Jan. 14, 2022.

(51) Int. Cl. G06Q 10/0631

(52) U.S. Cl. CPC G06Q 10/063114

(57) ABSTRACT

A computer implemented method for validating the veracity of a completed task is disclosed. The method includes receiving and storing registration data from a user, supervisor, and institution. The method receives case information from the user. The method determines if the second device stamp is within a predetermined threshold. If the predetermined threshold is satisfied, then the method sends to the supervisor, a message for approval of the case data. If an approval is received, then the method sends a second message to the user. The method receives a third message from the user. The third message comprises the second message and a request for a token for the approved case. The method sends the third message to a blockchain to receive the token associated with the approved case. The method sends to least one of the user, supervisor, and institution the token associated with the approved case.

### CROSS-REFERENCE TO RELATED APPLICATIONS

This application claims the benefit of U.S. Provisional Application No. 63/299,642, titled “METHODS FOR VALIDATING THE VERACITY OF A COMPLETED TASK”, and filed Jan. 14, 2022, the subject matter of which is hereby incorporated by reference in its entirety.

### STATEMENT REGARDING FEDERALLY SPONSORED RESEARCH OR DEVELOPMENT

Not applicable.

### INCORPORATION BY REFERENCE OF MATERIAL SUBMITTED ON A COMPACT DISC

Not applicable.

### TECHNICAL FIELD

The present disclosure relates to the field of medical programs, and more specifically to the field of validating case procedures in a residency program.

### BACKGROUND

Once medical students graduate, they become enter a residency program in a teaching institution, or hospital, to start specialized training in a particular field of medicine. Residents may provide care to patients in the teaching institution and are supervised by an attending physician from the teaching institution. The attending physician is an expert medical doctor that has completed all residency training Each patient that a resident provides care to is considered a case that must be documented for the teaching institution. Each case is accredited by a third-party clearing house.

However, the current system of accrediting cases for the teaching institution has problems. A large percentage of input cases are inaccurate in some manner, whether it is date, procedure, duration, etc. A major issue is validating if residents have actually completed the cases that they have alleged they have completed. During residency, each resident must complete several cases. With many residents, the large number of cases to be reviewed is impossible for the residency program in the teaching institution to validate because the institution has to validate the veracity of the attributes of those cases, and if the students completed those cases. Difficulty in accurately confirming cases causes the institution to incorrectly accept cases from residents. Residents may incorrectly be given degrees if they have lied about or incorrectly input information of the cases that they allegedly completed. This source of fraud can cause institutions to lose credibility of their programs.

In many businesses or institutions, tasks by employees must be accurately recorded in order to avoid consequences that may lead to malpractice or more than expected costs and expenses. Without an effective process of validating completed tasks, businesses and institutions will continue to output a growing number of mistakes. The prior art fails to provide an immutable recordkeeping system that effectively prevents incorrect information and data from being stored.

As a result, there exists a need for improvements over the prior art and more particularly for a more efficient way of verifying the accuracy of completed tasks.

### SUMMARY

A system and method for validating the veracity of a completed task is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a computer implemented method for validating the veracity of a completed task is disclosed. The system includes receiving, with a transceiver of a first computing device, registration data from a second computing device associated with a user. The system further includes storing, in a user record in an attached database, registration data associated with the user. The system receives, with the transceiver, registration data from a third computing device associated with a supervisor. The system stores, in a supervisor record in an attached database, registration data associated with the supervisor. The system receives, with the transceiver, registration data from a fourth computing device associated with an institution; storing, in an institution record in an attached database, registration data associated with the institution. The system receives, with the transceiver, case information from the second computing device. The case information includes (i) attributes about the case including case data, date, time and geolocation of when and where the case was performed and (ii) the date, time and geolocation of when and where the case information was input into the second computing device by the user (“second device stamp”). The system determines, with a processor of the first computing device, if the second device stamp is within a predetermined threshold of the date, time and geolocation of when and where the case was performed. If the predetermined threshold is satisfied, then sending with the transceiver to the third computing device of the supervisor, a message for approval of the case data. The message includes the case attributes. The system receives, with the transceiver, a response to the message from the third computing device of the supervisor, the response including at least one of an approval and a rejection of the message for approval. If an approval is received, then the system sending with the transceiver, a second message to the second computing device. The second message includes the case attributes of an approved case, a second device stamp, and the approval from the supervisor. The system receives with the transceiver, a third message from the second computing device. The third message comprises the second message and a request for a token for the approved case. The system sends with the transceiver, the third message to a blockchain. The system receives, with the transceiver, from the blockchain, the token associated with the approved case. The system sends, with the transceiver, to least one of the second computing device, third computing device and fourth computing device the token associated with the approved case.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the disclosure and together with the description, explain the principles of the disclosed embodiments. The embodiments illustrated herein are presently preferred, it being understood, however, that the disclosure is not limited to the precise arrangements and instrumentalities shown, wherein:

FIG. 1 is a diagram of an operating environment that supports a system for validating the veracity of a completed task, according to an example embodiment;

FIG. 2 is a schematic illustrating communication between the entities in FIG. 1 in relation to validating the veracity of a completed task, according to an example embodiment;

FIG. 3A is a block diagram of the order and data in the messages in the system, according to an example embodiment.

FIG. 3B is a block diagram of the blockchain pertaining to case information received for providing verified case information between a plurality of users, supervisors, and institutions, according to an example embodiment;

FIG. 3C is a block diagram of the blockchain pertaining to case information received for providing verified case information between a plurality of users, supervisors, and institutions, according to an example embodiment;

FIG. 4 is a diagram illustrating steps for a method of recording a resident record, a supervisor record, and an institution record, according to an example embodiment.

FIG. 5 is a diagram illustrating steps for a method of validating case information, according to an example embodiment.

FIG. 6A is a diagram illustrating steps for a method of grouping a plurality of tokens in a wallet, according to an example embodiment.

FIG. 6B is a diagram illustrating steps for a method of verifying whether aggregated tokens have met predetermined goals, according to an example embodiment.

FIG. 7A is a diagram illustrating a graphical user interface including a list of procedures configured to be displayed on a computing device, according to an example embodiment.

FIG. 7B is a diagram illustrating a graphical user interface including a procedure report configured to be displayed on a computing device, according to an example embodiment.

FIG. 7C is a diagram illustrating a graphical user interface of a wallet and a plurality of tokens configured to be displayed on a computing device, according to an example embodiment.

FIG. 8 is a block diagram of a system including a computing device and other computing devices, according to an exemplary embodiment of present technology.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions, or modifications may be made to the elements illustrated in the drawings, and the methods described herein may be modified by substituting reordering or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a system that accurately validates a completed task. When a user, or resident, documents a completed case, the cases information including case attributes is sent to the attending physician, or supervisor, of the respective case. The supervisor must approve the case attributes in order for the user to send the case information to the server, which hashes and stores the case information along with case approval to the blockchain. The blockchain assigns an NFT to the user to be stored in a wallet. The NFTs represent proof of approved case information allowing the institution to receive an aggregate number of verified NFTs corresponding to predetermined requirements.

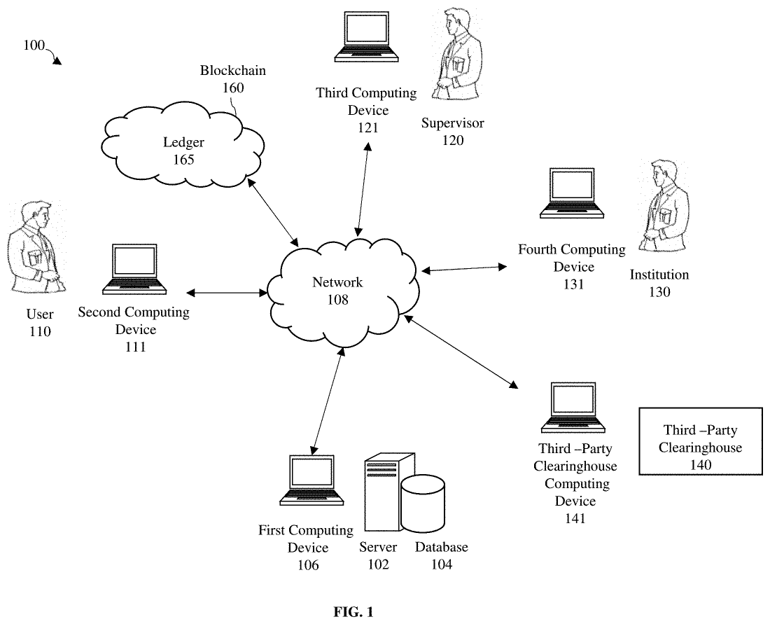

Referring now to the Figures, FIG. 1 is a diagram of an operating environment that supports a system 100 for validating the veracity of a completed task between a plurality of users over a communications network in accordance with the principles of the present invention, according to an example embodiment. The most prominent element of FIG. 1 is the server 102 associated with repository or database 104 and further coupled with network 108, which can be a circuit switched network, such as the Public Service Telephone Network (PSTN), or a packet switched network, such as the Internet or the World Wide Web, the global telephone network, a cellular network, a mobile communications network, or any combination of the above. In one embodiment, network 108 is a secure network wherein communications between endpoints are encrypted so as to ensure the security of the data being transmitted. Server 102 is a central controller or operator for the functionality that executes on at least a user computing device 111, via various methods.

The networked environment may also include a blockchain system 160 for storing one or more distributed ledgers 165 that records “transactions”, such as adding information including case attributes, device stamp, and an approval from a supervisor. The transactions are bundled into blocks and every block (except for the first block) refers to or is linked to a prior block in the chain. Computer nodes may maintain the blockchain and cryptographically validate each new block and thus the transactions contained in the corresponding block. A ledger is a record-keeping system that tracks the transactions in accounts. Unlike a centralized ledger, the data in the distributed ledger is immutable because the data is stored on multiple nodes, which are connected independent computers in a network, making it impossible to change the information in the data.

A block chain or blockchain is a distributed database that maintains a list of data records on the ledger. The security of the block chain enhanced by the distributed nature of the block chain. A block chain typically includes several nodes. Each of the nodes may be one or more computers, databases, data stores, machines, operably connect to one another. In some cases, each of the nodes or multiple nodes are maintained by different entities. A block chain typically works without a central repository or single administrator. The data records recorded in the block chain are enforced cryptographically and stored on the nodes of the block chain. A block chain provides numerous advantages over traditional databases. The nodes of a block chain may reach a consensus regarding the validity of a transaction contained on the transaction ledger. The block chain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, for example, when someone sends cryptocurrency to another person, and blocks are created by users known as “miners” who use specialized software/equipment to create blocks. In the present invention, after the user access the system or provides payload data, such information will be recorded on the blockchain.

Users of the block chain create transactions that are passed around to various nodes of the block chain. A “valid” transaction is one that can be validated based on a set of rules that are defined by the particular system implementing the block chain. For example, in the case of present invention, a valid transaction is a user's case information that has approval from a supervisor, in some cases, that meets other criteria. In some block chain systems, miners are incentivized to create blocks by a rewards structure that offers a pre-defined per-block reward and/or fees offered within the transactions validated themselves. Thus, when a miner successfully validates a transaction on the block chain, the miner may receive rewards and/or fees as an incentive to continue creating new blocks.

FIG. 1 further includes a first computing device, a second computing device, a third computing device, and a fourth computing device, which each may be smart phones, mobile phones, tablet computers, handheld computers, laptops, or the like. A second computing device 111 corresponds to a user 110. A third computing device 121 corresponds to a supervisor 120. A fourth computing device 131 corresponds to an institution 130. Each of the computing devices include a user interface and/or graphical user interface. In certain embodiments, the system may communicate between the user, the supervisor, the institution, and the third-party clearing house, over the communications network. The user is a resident in a residency program. The supervisor is the attending physician. The institution is the teaching hospital providing the residency program. The third-party clearinghouse accredits the case information documented by the user. The users input registration data via a graphical user interface on the second computing device 111 to be sent through the communications network via a data packet and stored in the database. The supervisors input registration data via a graphical user interface on the third computing device 121 to be sent through the communications network via a data packet and stored in the database. The institutions input registration data via a graphical user interface on the fourth computing device 131 to be sent through the communications network via a data packet and stored in the database. The registration data may include at least one of a user name, email address, physical address, phone numbers, password, biometric information, password, security questions and answers.

FIG. 1 further shows that server 102 includes a database or repository 104, which may be one or more of a relational databases comprising a Structured Query Language (SQL) database stored in a SQL server, a columnar database, a document database and a graph database. Computing devices 111 and 121 may also each include their own database. The repository 104 serves data from a database, which is a repository for data used by server 102 and the mobile devices during the course of operation of the invention. Database 104 may be distributed over one or more nodes or locations that are connected via network 108.

The software is configured to create and store records for the users, supervisors, and institutions. The database 104 may include a stored record for each of the users, supervisors, and institutions in the system. The database may be configured to not only store registration data but also store personal identifying information (“PII”) and non-personal identifying information data. PII means information that identifies, relates to, describes, is capable of being associated with, or could reasonably be linked, directly or indirectly, with a particular user. PII data includes, but is not limited to, the following if it identifies, relates to, describes, is capable of being associated with, or could be reasonably linked, directly or indirectly, with a particular user: Identifiers such as a real name, alias, postal address, unique personal identifier, online identifier, Internet Protocol address, email address, account name social security number, driver's license number, passport number, or other similar identifiers; Commercial information, including records of personal property, products or services purchased, obtained, or considered, or other purchasing or consuming histories or tendencies; Biometric Information, such as fingerprint or facial recognition; Internet or other electronic network activity information, including, but not limited to, browsing history, search history, and information regarding a consumer's interaction with an Internet Web site, application, or advertisement; Geolocation data; Audio, electronic, visual, thermal, olfactory, or similar information; Professional or employment related information; Education information, defined as information that is not publicly available personally identifiable information; and, Inferences drawn from any of the information to create a profile about a consumer reflecting the consumer's preferences, characteristics, psychological trends, predispositions, behavior, attitudes, intelligence, abilities, and aptitudes. The PII may further include the telephone number/email address/social network handle of the user, demographic data for the user, such as age, sex, income data, race, color, marital status, etc. Non PII data may include information that is anonymous and cannot identify the user. Non PII data helps protect the user such that the information may not be used to harm the user. Non PII data may include device type, browser type, language preference, time zone, etc.

The blockchain 160 stores case information from the user, which may include attributes about the case including case data, date, time, and geolocation of when and where the case was performed, the date, time and geolocation of when and where the case information was input into the second computing device by the user (“second device stamp”). The blockchain also stores an approval from the supervisor of a case.

FIG. 1 shows an embodiment wherein networked computing devices 111 and 121 may interact with server 102 and repository 104 over the network 108. Server 102 includes a software engine that delivers applications, data, program code and other information to networked computing devices 111 and 121. The software engine of server 102 may perform other processes such as audio and/or video streaming or other standards for transferring multimedia data in a stream of packets that are interpreted and rendered by a software application as the packets arrive. It should be noted that although FIG. 1 shows only two networked mobile computing devices 111 and 121, the system of the present invention supports any number of networked mobile computing devices connected via network 108, having at least the second computing device 111, the third computing device 121, and the fourth computing device 131.

Server 102 also includes program logic comprising computer source code, scripting language code or interpreted language code that is compiled to produce executable file or computer instructions that perform various functions of the present invention. In another embodiment, the program logic may be distributed among more than one of server 102, computing devices 111, 121 and 131, or any combination of the above.

Note that although server 102 is shown as a single and independent entity, in one embodiment of the present invention, the functions of server 102 may be integrated with another entity, such as each of computing devices 111, 121, and 131. Further, server 102 and its functionality, according to a preferred embodiment of the present invention, can be realized in a centralized fashion in one computer system or in a distributed fashion wherein different elements are spread across several interconnected computer systems. While the blockchain is illustrated as a single entity, the blockchain is actually decentralized, meaning that the data in the blockchain is stored into multiple nodes of the network. The decentralized nature of the blockchain allows the data stored within the blockchain to be immutable.

The third-party clearinghouse 140 may be a single computing device, or system connected computing devices. A third-party clearing house 141 computing device may be used as an additional layer or source to verify the authenticity of a user computing device and its associated user. For example, the system may use the third-party computing device to further evaluate attributes not stored on database of the system to validate the user's identity. For example, the system may use third party computing device as another source to validate the case information documented by the user. By way of another example, the system may use third-party computing device as another source to validate the attributes about the case and the second device stamp.

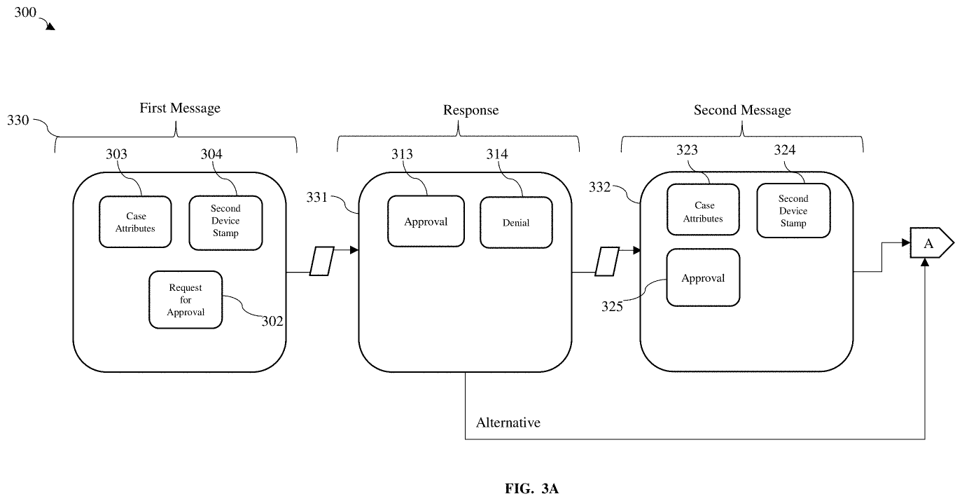

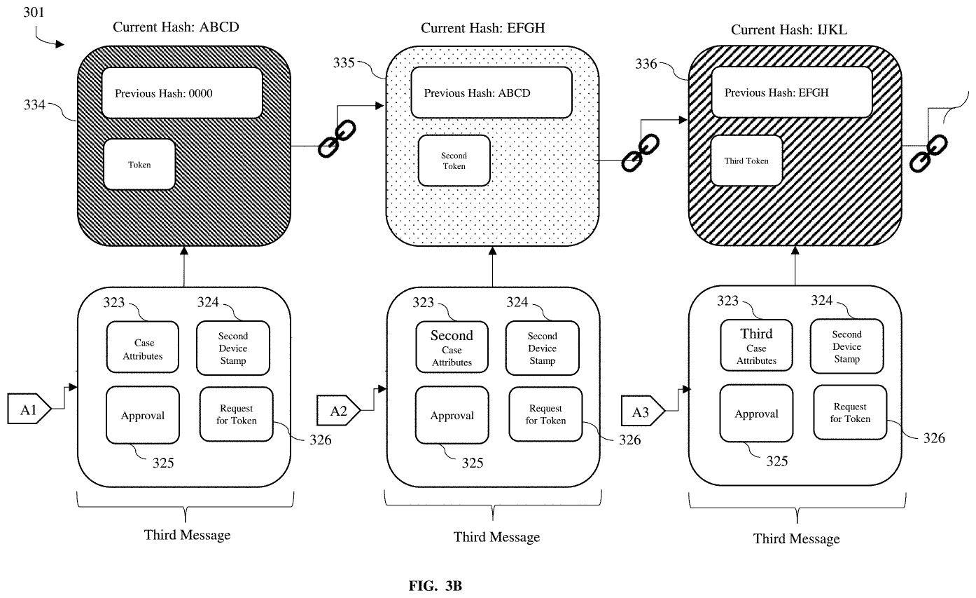

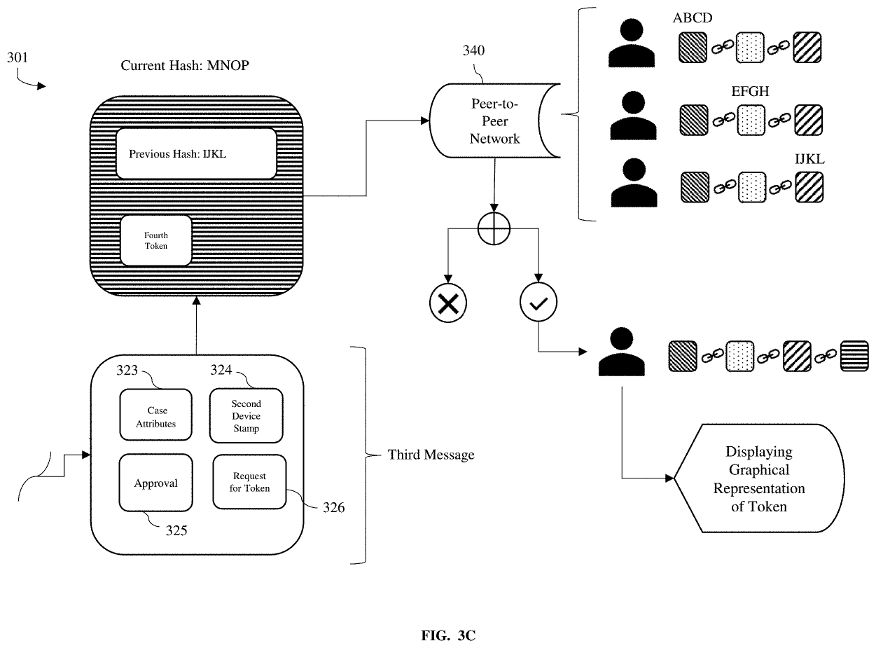

Referring now to FIG. 3A, a block diagram of the order and data in the messages in the system 100, according to an example embodiment. A first message 330 is sent from the user to the supervisor when the user wants to request approval for case information. The first message comprises case attributes 303, the second device stamp 304, and a request for approval 302. The supervisor sends a response message 331 to the server to notify the user whether the supervisor approves or denies the case attributes. The response message includes either an approval 313 of the case attributes or a denial 314 of the case attributes. If the supervisor approves the case attributes, the server sends a second message 332 to the user associate with the case. The second message comprises the case attributes 323, the second device stamp 324, and the approval 325 of the case attributes.

Referring now to FIG. 3B, a block diagram of the blockchain 301 pertaining to case information received for providing verified case information between a plurality of users, supervisors, and institutions, according to an example embodiment. To validate case information, the second computing device of the user sends a third message to the blockchain the server sends the user the second message. Additionally, the computer software captures other identifying information related to the user associated with the case including a second device stamp that includes the date, time, and geolocation of when and where the case information was input into the second computing device by the user. The third message includes case attributes 323, the second device stamp 324, the approval 325 of the case attributes, and a request for a token 326. Referring to FIG. 3, after authenticating the case information, an algorithm is applied to the information 301 before storing the information on the ledger in blockchain format. Each of the blocks illustrated in FIG. 3 illustrate a token awarded to a user. For example, after the case information associated with the user is approved, an algorithm is applied to the received third message to produce a third message hashed value that is stored on the ledger in blockchain format. Each of the blocks 334, 335, 336 includes third message hashed values from each of the third messages from the user. As illustrated in FIG. 3B, each of the blocks includes data related to each third message from the user including case attributes 323, second device stamp 324, approval 325, and request for a token 326. Referring to FIG. 3C, the most recent block is illustrated being validated by the peer-to-peer network 340. Once the block is validated and stored on the blockchain, the NFT is awarded to the user to be displayed on the computing devices.

By way of example, if user logs in from a remote computing device having a geolocation outside a predetermined distance of threshold than the geolocation of the remote computing device of most of the user's previous logins recorded on the blockchain ledger, then the system may send a message to verify the identity of the user. Additionally, in other embodiments, the user may send messages to a fourth party to contact the user to authenticate the user. After verifying login information of the users and determining that the first pattern is within the first threshold, or verifying authenticity of the vendor user, the software is configured to transmit and will transmit, over the communications network, payload data to be displayed on the remote computing device of another user.

The software is also configured for displaying to device of the user a user interface for receiving payload tokenizing information related to the payload each user. The payload information may include any payload type information that the user wants verified. The payload tokenizing information may include wherein the payload tokenizing information includes, email addresses, IP addresses, business entity information (name, address, email domain etc.), physical addresses, phone numbers, banking information (EFT information, swift codes, routing number, account number, bank branch contact information, geolocation of bank, IP addresses of bank), etc.

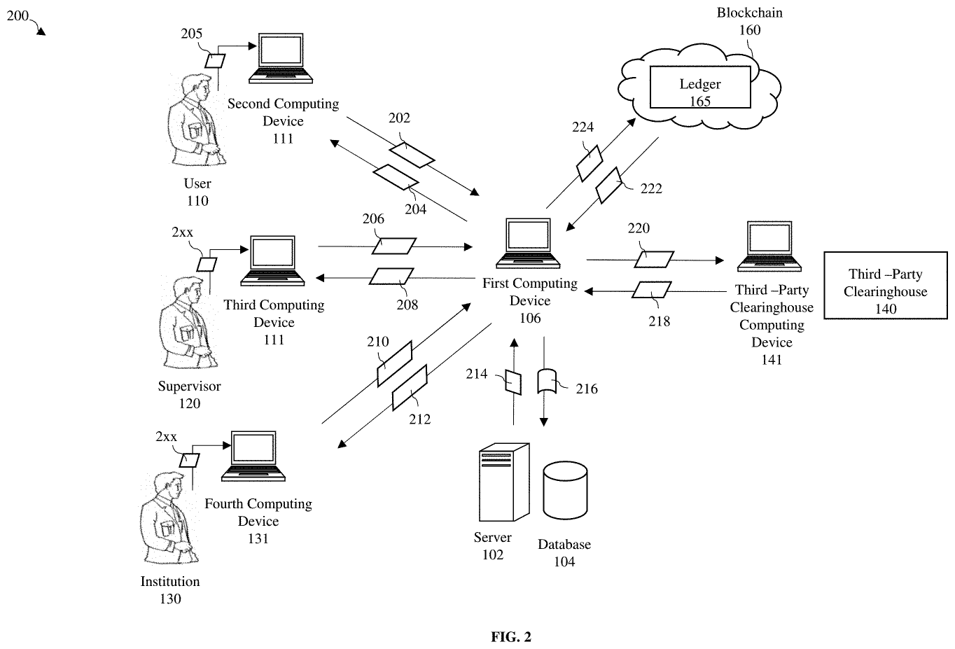

The process for providing non-repudiation of communications online will now be described with reference to FIGS. 2 and 4 through 5B. FIGS. 2 and 4 through 5B depict, among other things, data flow and control flow in the process for providing non-repudiation of communications online, according to one embodiment. FIG. 2 is a schematic illustrating communication between the entities in FIG. 1 in relation to validating the veracity of a completed task, according to an example embodiment. It is understood that in FIG. 2, the data packets 205, 210, 215, 225, 230, 235, and 240 are used to show the transmission of data and may be used at different stages of the process. The user 110 may use the computing device 111 to communication with the server 102, which includes the database 104 and blockchain 160 of distributed ledgers 165.

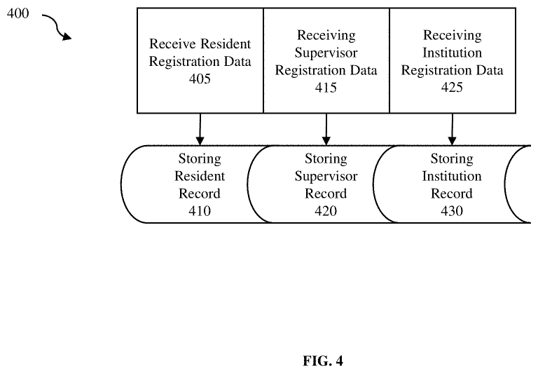

Referring now to FIG. 4, a diagram illustrating steps for a method of recording a user record, a supervisor record, and an institution record, according to an example embodiment. The server may provide a specific graphical user interface for each of the user, supervisor, and institution allowing the user 110, supervisor 120, and institution 130 to input registration data. The computing devices 111, 121, and 131 may provide other user information to be included in the registration data. Registration data may vary for each of the user, supervisor, and institution. In step 405, the first computing device 106 via a transceiver receives registration data from the second computing device associated with the user. The server 102 associated with the first computing device creates a user record in an attached database 104. In step 410, the server stores the registration data associated with the user into the user record in the attached database. In step 415, the first computing device 106 via the transceiver receives registration data from the third computing device 121 associated with the supervisor. The server 102 associated with the first computing device creates a supervisor record in an attached database 104. In step 420, the server stores the registration data associated with the supervisor into the supervisor record in the attached database. In step 425, the first computing device 106 via the transceiver receives registration data from the fourth computing device 131 associated with the institution. The server 102 associated with the first computing device creates an institution record in an attached database 104. In step 430, the server stores the registration data associated with the institution into the institution record in the attached database.

It is understood that this method is a continuous cycle and that each step of method 400 may operate concurrently with another step of method 400 to create and store records. In other embodiments, the method may further include additional steps to create and store records consistent with the systems disclosed herein.

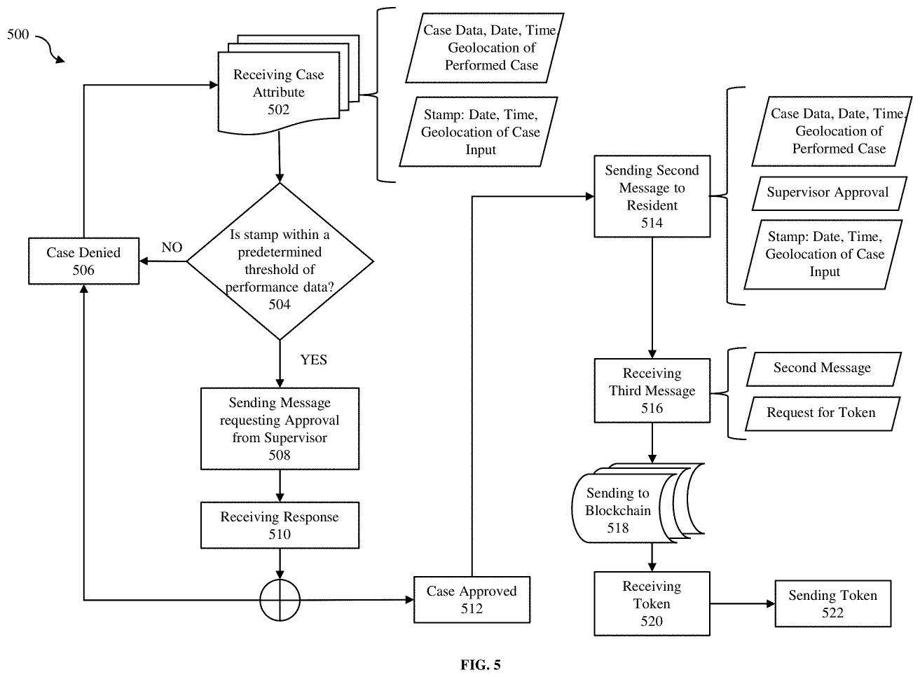

FIG. 5 is a diagram illustrating steps for a method 500 of validating case information, according to an example embodiment. The server may provide a graphical user interface allowing the user 110 to input information to be included in the case information. The case information includes attributes about the case including case data, date, time and geolocation of when and where the case was performed, and the date, time and geolocation of when and where the case information was input into the second computing device by the user (“second device stamp”). Case data may include the type of procedure performed, patient name, and attending physician name. However, other information about the case may be included in the case data. In step 502, once the user enters the case information, the second computing device 111 sends data packet 202 including case information. The first computing device 106 receives the data packet 202 including case information through the transceiver. In step 504, the processor of the first computing device determines if the second device stamp is within a predetermined threshold of performance data. Performance data includes a predetermined threshold of the date, time and geolocation of when and where the case was performed. If the predetermined threshold is not satisfied, then the case information is denied in step 506. The first computing device may send a denial message via data packet 204 to the second computing device 111. The denial message may notify the user that the user must re-input the case information in step 502. If the predetermined threshold is satisfied, then the first computing device 106 sends via the transceiver data packet 208 including a message for approval of the case data to the third computing device 121 of the supervisor 120 in step 508. The message includes the case attributes and a request for approval from the supervisor. The message may also include a graphical user interface allowing the supervisor to interact with the request for approval. The supervisor enters a response and sends the response in data packet 206. In step 510, the first computing device receives via the transceiver data packet 206 including the response to the message. The response includes at least one of an approval and a rejection of the message for approval. If the response only includes a rejection, then the case is denied in step 506. The first computing device may send the denial message via data packet 204 to the second computing device 111. The denial message may notify the user that the user must re-input the case information in step 502. If the response only includes an approval, then the case is approved in step 512. In step 514, the first computing device sends via the transceiver data packet 204 including a second message to the second computing device. The second message includes the case attributes of an approved case, a second device stamp, and the approval from the supervisor. The second message may also include a graphical user interface allowing the user to send a third message including the second message and a request for a token for the approved case. The second computing device sends data packet 202 including the third message. In step 516, the first computing device receives via the transceiver data packet 202 from the second computing device. The first computing device sends data packet 224 including the third message to the blockchain 160 in step 518. In step 520, the first computing device receives via the transceiver a token in data packet 222 from the blockchain. The token is a form of receipt that is associated with the approved case. The token is assigned to the public key that is assigned to the user. Then, in step 522, the first computing device sends via the transceiver data packets 204, 208, 212, which all include a graphical representation of the token associated with the approved case. Data packet 204 is sent to the second computing device. Data packet 208 is sent to the third computing device. Data packet 212 is sent to the fourth computing device.

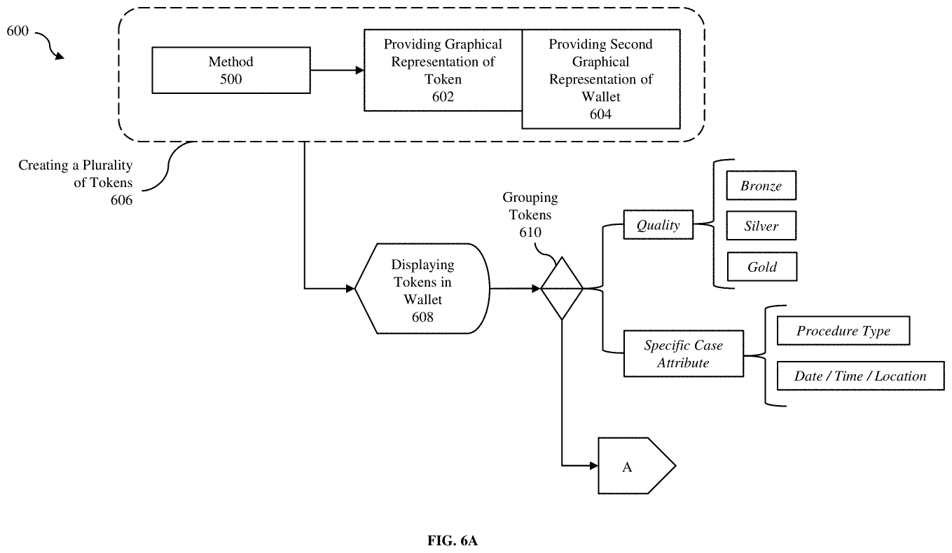

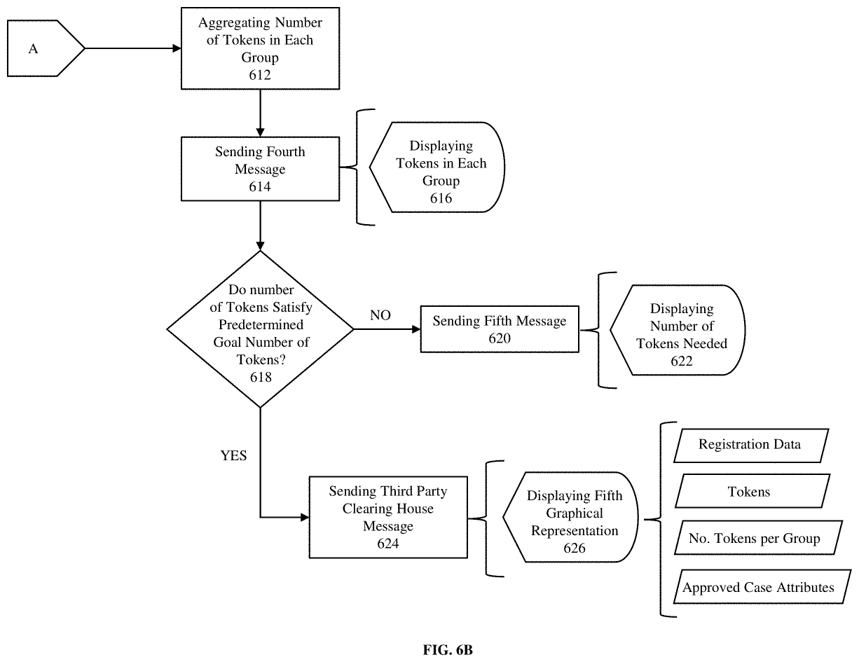

Referring now to FIGS. 6A and 6B, a diagram illustrating steps for a method 600 of grouping and aggregating tokens, according to an example embodiment. FIG. 6A is a diagram illustrating steps for a method 600 of grouping a plurality of tokens in a wallet, according to an example embodiment. FIG. 6B is a diagram illustrating steps for a method of verifying whether aggregated tokens have met predetermined goals, according to an example embodiment. Shown in FIG. 6A, in step 602, the first computing device provides a graphical representation of the token. In step 604, the first computing device provides a second graphical representation of the wallet that is displayed on at least one of the second computing device, the third computing device, and the fourth computing device. Each user is a assigned a wallet that displays a plurality of tokens. In step 606, method 500 and steps 602, 604 are repeated to create the plurality of tokens for a plurality of approved case associated to the user. In step 608, each first token of the plurality of tokens is displayed in the wallet on at least one of the second computing device, the third computing device, and the fourth computing device. In step 610, using the processor, the computing devices 111, 121, and 131 group the plurality of first tokens, based on the case attributes of the first tokens, into a predetermined group of a plurality of predetermined groups. Each of the predetermined groups corresponds to a specific case attribute.

Shown in FIG. 6B, in step 612, the first computing device 106 aggregates the number of tokens in each of the predetermined groups. In step 614, the first computing device sends via the transceiver data packet 204, 208, and 212, which include a fourth message, to at least one of the second computing device, the third computing device, and the fourth computing device. The fourth messages include a third graphical representation of the first tokens within each predetermined group. In step 616, the computing devices 111, 121, and 131 displays the third graphical representation of the tokens in each group. In step 618, using the processor, the computing device determines if a total number of first tokens within each predetermined group satisfies a predetermined goal for each respective specified case attribute. If the predetermined goal is not met, in step 620, the first computing device sends a fifth message via data packets 204, 208, and 212 including a fourth graphical representation of first tokens needed within the predetermined group to satisfy the predetermined goal. In step 622, the computing devices 111, 121, and 131 display the fourth graphical representation. If the predetermined goal is met, in step 624, the first computing device sends data packet 220 including a third-party clearing house message to a third-party clearing house computing device 141. The third-party clearing house message comprises a fifth graphical representation that includes the registration data from the second computing device associated with the user and the total number of first tokens within each predetermined group. In step 626, the third-party clearing house computing device 141 displays the fifth graphical representation.

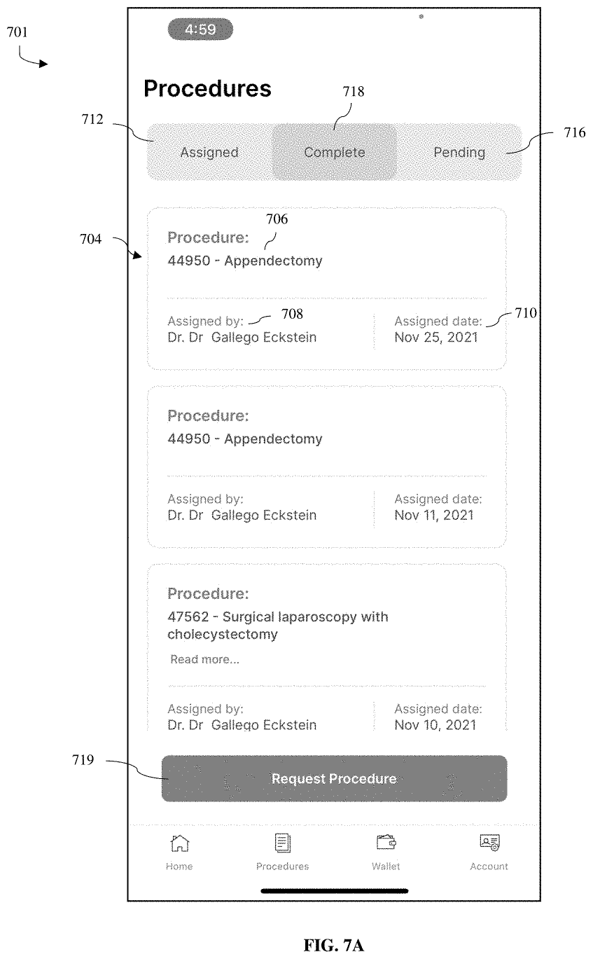

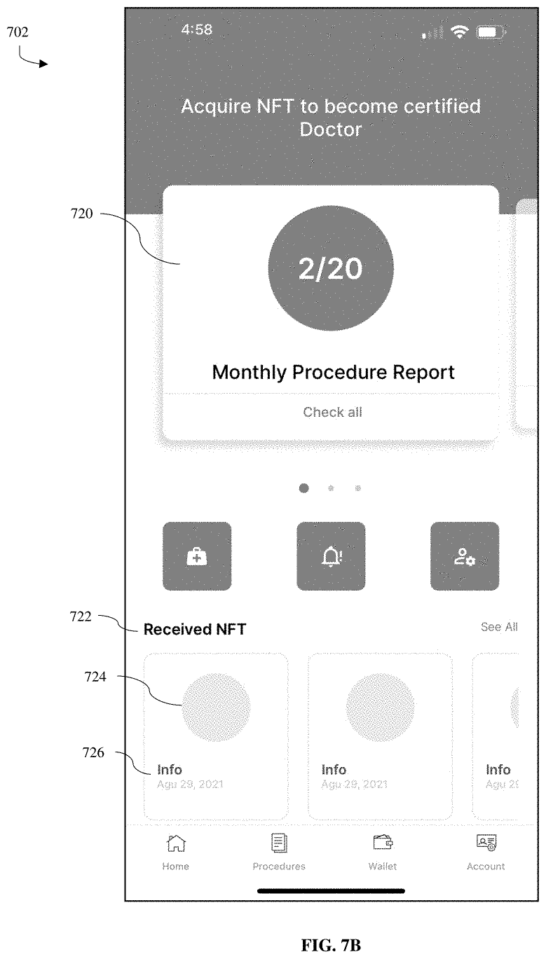

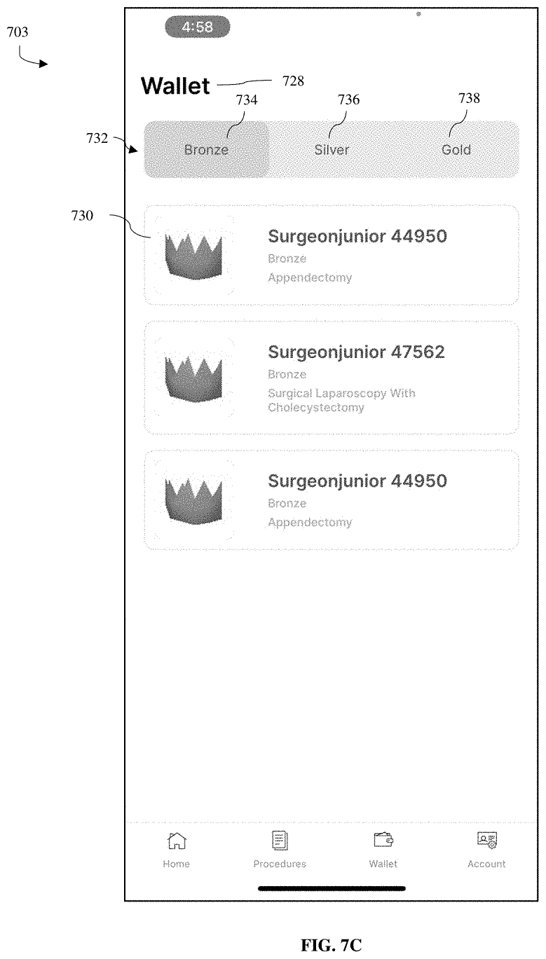

Referring now to FIG. 7A, a diagram illustrating a graphical user interface 701, or user interface, including a list of procedures configured to be displayed on a computing device shown, according to an example embodiment. The user interface may be displayed on a second computing device 111. The user interface may include procedures entries 704. The procedure entries represent the cases associated with the user. The procedures entries may include the procedure name 706, name of attending that assigned the procedure 708, and the assigned date 710. The user interface may include an assigned tab 712, a completed tab 714, and a pending tab 716. The user may click on the assigned tab to view a list of assigned procedures. The user may click on the completed tab to view a list of completed procedures. The user may click on the pending tab to view a list of requested procedures that are awaiting approval from the supervisor. The user interface may also include a button 719 that the user may click on to request a procedure.

Referring now to FIG. 7B, a diagram illustrating a graphical user interface 702, or user interface, including a procedure report configured to be displayed on a computing device shown, according to an example embodiment. The user interface includes a graphical representation of a monthly procedure report 720. The monthly procedure report may track the number of procedures completed by the user. The user interface may include a list of received NFTs 722. Each entry in the list may include the NFT 724, which is a graphical representation of the token in the blockchain. The entries may also include the date 726 that the NFT was received.

Referring now to FIG. 7C, a diagram illustrating a graphical user interface 703, or user interface, including a wallet and a plurality of tokens configured to be displayed on a computing device is shown, according to an example embodiment. The user interface may be displayed on a second computing device 111. The user interface may include the second graphical representation of the wallet 728 that includes the graphical representations of the plurality of tokens 730. The user interface may include a graphical bar 732 comprising a tab for bronze 734, silver 736, and gold 738. Each of the tabs allow the user to view bronze tokens, silver tokens, and gold tokens, respectively.

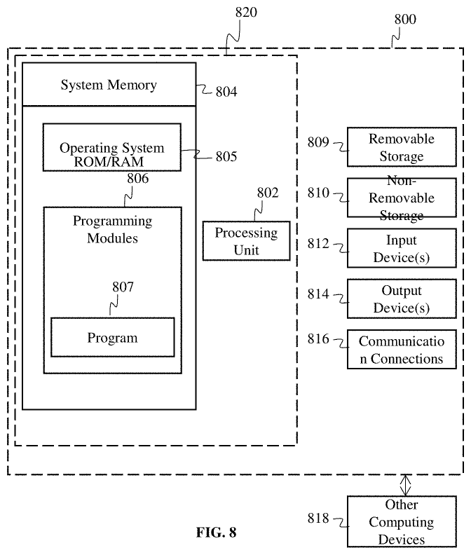

FIG. 8 is a block diagram of a system including an example computing device 800 and other computing devices. Consistent with the embodiments described herein, the aforementioned actions performed by devices 106, 111, 121, 131 may be implemented in a computing device, such as the computing device 800 of FIG. 8. Any suitable combination of hardware, software, or firmware may be used to implement the computing device 800. The aforementioned system, device, and processors are examples and other systems, devices, and processors may comprise the aforementioned computing device. Furthermore, computing device 800 may comprise an operating environment for systems 100 and processes 400, 500, 600 and other described herein, providing data related to data flow 200 and GUIS illustrated in FIG. 5 described above. Processes 400, 500, 600 and other described herein, data related to data flow 200 and other described herein and GUI illustrated in FIG. 7A and others described herein may operate in other environments and are not limited to computing device 800.

With reference to FIG. 8, a system consistent with an embodiment of the invention may include a plurality of computing devices, such as computing device 800. In a basic configuration, computing device 800 may include at least one processing unit 802 and a system memory 804. Depending on the configuration and type of computing device, system memory 804 may comprise, but is not limited to, volatile (e.g. random access memory (RAM)), non-volatile (e.g. read-only memory (ROM)), flash memory, or any combination or memory. System memory 804 may include operating system 805, and one or more programming modules 806. Operating system 805, for example, may be suitable for controlling computing device 800's operation. In one embodiment, programming modules 806 may include, for example, a program module 807 for executing the actions of devices 106, 111, 121, 131, for example. Furthermore, embodiments of the invention may be practiced in conjunction with a graphics library, other operating systems, or any other application program and is not limited to any particular application or system. This basic configuration is illustrated in FIG. 7 by those components within a dashed line 820.

Computing device 800 may have additional features or functionality. For example, computing device 800 may also include additional data storage devices (removable and/or non-removable) such as, for example, magnetic disks, optical disks, or tape. Such additional storage is illustrated in FIG. 6 by a removable storage 809 and a non-removable storage 810. Computer storage media may include volatile and nonvolatile, removable and non-removable media implemented in any method or technology for storage of information, such as computer readable instructions, data structures, program modules, or other data. System memory 804, removable storage 809, and non-removable storage 810 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a camera, a touch input device, etc. Output device(s) 814 such as a display, speakers, a printer, etc. may also be included. The aforementioned devices are only examples, and other devices may be added or substituted.

Computing device 800 may also contain a communication connection 816 that may allow device 800 to communicate with other computing devices 818, such as over a network in a distributed computing environment, for example, an intranet or the Internet. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 804, including operating system 805. While executing on processing unit 802, programming modules 806 (e.g. program module 807) may perform processes including, for example, one or more of the stages of the methods 400, 500, 600 as described above. The aforementioned processes are examples, and processing unit 802 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A computer implemented method for validating the veracity of a completed task, wherein the method comprises:
a. receiving, with a transceiver of a first computing device, registration data from a second computing device associated with a user;
b. storing, in a user record in an attached database, registration data associated with the user;
c. receiving, with the transceiver, registration data from a third computing device associated with a supervisor;
d. storing, in a supervisor record in an attached database, registration data associated with the supervisor;
e. receiving, with the transceiver, registration data from a fourth computing device associated with an institution;
f. storing, in an institution record in an attached database, registration data associated with the institution;
g. receiving, with the transceiver, case information from the second computing device; wherein the case information includes (i) attributes about the case including case data, date, time and geolocation of when and where the case was performed and (ii) the date, time and geolocation of when and where the case information was input into the second computing device by the user (“second device stamp”);
h. determining, with a processor of the first computing device, if the second device stamp is within a predetermined threshold of the date, time and geolocation of when and where the case was performed;
i. wherein, if the predetermined threshold is satisfied, then sending with the transceiver to the third computing device of the supervisor, a message for approval of the case data, wherein the message including the case attributes;
j. receiving, with the transceiver, a response to the message from the third computing device of the supervisor, the response including at least one of an approval and a rejection of the message for approval;
k. wherein, if an approval is received, then sending with the transceiver, a second message to the second computing device, wherein the second message includes the case attributes of an approved case, a second device stamp, and the approval from the supervisor;
l. receiving with the transceiver, a third message from the second computing device, wherein the third message comprises the second message and a request for a token for the approved case;
m. sending with the transceiver, the third message to a blockchain;
n. receiving, with the transceiver, from the blockchain, the token associated with the approved case; and
o. sending, with the transceiver, to least one of the second computing device, third computing device and fourth computing device the token associated with the approved case.

2. The method of claim 1, further comprising providing a graphical representation of the token for displaying in a second graphical representation of a wallet that is displayed on at least one of the second computing device, the third computing device, and the fourth computing device.

3. The method of claim 2, wherein the method further comprises creating a plurality of first tokens for a plurality of approved cases.

4. The method of claim 3, wherein each first token of the plurality of tokens is displayed in the wallet on at least one of the second computing device, the third computing device, and the fourth computing device.

5. The method of claim 4, wherein the method further comprises grouping, with the processor, the plurality of first tokens, based on the case attributes of the first tokens, into a predetermined group of a plurality of predetermined groups, wherein each of the predetermined groups corresponds to a specific case attribute.

6. The method of claim 5, wherein the method further comprises sending, with the transceiver to at least one of the second computing device, the third computing device, and the fourth computing device, a fourth message comprising a third graphical representation of the first tokens within each predetermined group.

7. The method of claim 6, wherein the method further comprises determining, with the processor, if a total number of first tokens within each predetermined group does not satisfy a predetermined goal for each respective specified case attribute, then sending a fifth message comprising a fourth graphical representation of first tokens needed within the predetermined group to satisfy the predetermined goal.

8. The method of claim 6, wherein the method further comprises determining, with the processor, if a total number of first tokens within each predetermined group satisfies a predetermined goal for each respective specified case attribute, then sending a third party clearing house message to a third party clearing house computing device, wherein the third party clearing house message comprises a fifth graphical representation having the registration data from the second computing device associated with the user and the total number of first tokens within each predetermined group.
